(19) United States
(12) Patent Application Publication
(10) Pub. No.: US 2015/0282121 A1
(43) Pub. Date: Oct. 1, 2015

(54) LOCAL RESOURCE SHARING METHOD OF MACHINE TO MACHINE COMPONENT AND APPARATUS THEREOF

(71) Applicant: Electronics and Telecommunications Research Institute, Daejeon (KR)

(72) Inventors: Hyun-Joong KANG, Jinju-si (KR); Mal-Hee KIM, Daejeon (KR); Jae-Hak YU, Daejeon (KR); Hyo-Chan BANG, Daejeon (KR); Myung-Nam BAE, Daejeon (KR)

(21) Appl. No.: 14/629,117

(22) Filed: Feb. 23, 2015

(30) Foreign Application Priority Data
Mar. 26, 2014 (KR) 10-2014-0035539

(51) Int. Cl. H04W 72/04; H04W 4/00

(52) U.S. Cl. CPC H04W 72/04; H04W 4/005

(57) ABSTRACT

Exemplary embodiments of the present invention relates to a resource sharing for M2M service capabilities. A sharing local resource sharing method of M2M component according to an embodiment of the present invention comprises generating an replacement network service capability layer when a pre-determined component which is included in a device/gateway domain is not connected to a network domain or a pre-determined request is made; and performing communication with at least one of other components included in the device/gateway domain through the generated replacement NSCL. In exemplary embodiments of the present invention, M2M service capabilities may be replaced or changed according to system conditions.

### CROSS REFERENCE TO RELATED APPLICATION

This application claims the benefit of Korean Patent Application No. 10-2014-0035539, filed on Mar. 26, 2014, entitled “Local resource sharing method of machine to machine component and apparatus thereof”, which is hereby incorporated by reference in its entirety into this application.

### BACKGROUND

1. Technical Field

The present invention relates to a machine to machine service capability for resource sharing.

2. Description of the Related Art

A machine to machine communication is called in various names such as Machine to Machine (M2M) communication, Machine Type Communication (MTC), Internet of Things (IoT) and Device to Device (D2D) communication, etc. The machine to machine communication allows to share a variety of information between linkable machines and monitor the state each other remotely so that each machine can be actively and intimately operated.

Among them, European Telecommunications Standards Institute (ETSI) M2M communications is an application agnostic standard defining an end to end M2M functional architecture, the functional entities and the related reference points. It describes a resources-based architecture that can be used for the exchange of data and event information between machines involving communications across networks without requiring human intervention.

M2M standard defines an architecture supporting a distributed terminal to exchange data and event information with devices under the core network through M2M applications which are coupled to M2M service capabilities. However, M2M standard does not allow exchanging data and event between a gateway and a gateway or between a device and a device. Thus, when M2M service capabilities in the network domain do not operate, M2M applications cannot receive data or event information from components (gateways, devices) even though they exist under the same access network.

Accordingly, it is highly demanded to retain the stability of M2M service capabilities and collect data instantly in local networks. Furthermore, functional architecture is also demanded to support various server/gateway/device information, data and events in the condition of network fragmentation or in the case of failure of connection to M2M service capabilities.

### SUMMARY

Embodiments of the present invention allow to provide M2M services using components in the device/network domain in the condition of failure of connection to the network domain.

A local resource sharing method of M2M component according to an embodiment of the present invention comprises generating a replacement Network Service Capability Layer (NSCL) by a pre-determined component which is included in a device/gateway domain when the pre-determined component fails to make a connection to a network domain or a pre-determined request is made; and performing, by the pre-determined component, communication with at least one of other components included in the device/gateway domain through the generated replacement NSCL.

In an embodiment of the present invention, the method further comprises changing a service port for an original Service Capability Layer (SCL) which is already presented before the replacement NSCL is generated; and registering the original SCL under the replacement NSCL.

In an embodiment of the present invention, the method further comprises, after the step of generating a replacement NSCL, performing a connection request to the network domain; eliminating the replacement NSCL when being connected to the network domain; and restoring the original SCL. In an embodiment of the present invention, the method further comprises, when being connected to the network domain, transmitting information under sclBase of the network domain to components registered under the pre-determined component.

In an embodiment of the present invention, the method further comprises, after the step of generating a replacement NSCL, generating a Network Application (NA) in the device/gateway domain. The step of generating an NA comprises generating a NA based on metadata shared with the network domain or autonomously existing metadata.

In an embodiment of the present invention, the method further comprises broadcasting the generation of the replacement NSCL by the pre-determined component.

In an embodiment of the present invention, the pre-determined component is a M2M gateway or a M2M device.

In an embodiment of the present invention, the method further comprises performing, by a component which is included in a device/gateway domain and is not pre-determined, a connection request to the pre-determined component by referring to a pre-determined address list when fails to make a connection to a network domain or a pre-determined request is made.

In an embodiment of the present invention, the method further comprises, when a component, which is not pre-determined, fails to make a connection to all components existing in the address list, performing a service scan for the network; and connecting to the component which has responded to the service scan.

In an embodiment of the present invention, the method further comprises accessing, by the pre-determined component or the component which is not pre-determined, a server which manages the address list in order to upload or download the address list

In an embodiment of the present invention, the generating a replacement NSCL comprises generating the replacement NSCL in its own predetermined component or instructing to generate the replacement NSCL to an external device.

A machine to machine (M2M) component included in a device/gateway domain according to an embodiment of the present invention may comprise a replacement Network Service Capability Layer (NSCL) manager configured to generate a replacement NSCL inside the M2M component when a connection to a network domain is not made or there is a pre-determined request; and the replacement NSCL configured to perform communication with at least one of other components included in the device/gateway domain.

In an embodiment of the present invention, the M2M component may further comprise a local SCL manager configured to change a service port for an original Service Capability Layer (SCL) which is already presented before the replacement NSCL is generated, and register the original SCL under the replacement NSCL.

In an embodiment of the present invention, the M2M component may further comprise an N connection manager configured to perform a connection request to the network domain after the replacement NSCL is generated, wherein the replacement NSCL manager eliminates the replacement NSCL when the connection to the network domain is made, and wherein the local SCL manager restores the original SCL.

In an embodiment of the present invention, the replacement NSCL manager may generate an Network Application (NA) in the device/gateway domain. In an embodiment of the present invention, the NA may be generated based on metadata shared with the network domain or autonomously existing metadata.

In an embodiment of the present invention, the replacement NSCL manager may broadcast the generation of the replacement NSCL.

In an embodiment of the present invention, the M2M component may be a M2M gateway or a M2M device.

In an embodiment of the present invention, the M2M component may further comprise a SCL address list manager configured to access a server which manages an address list in order to upload or download the address list, wherein the address list comprise addresses of the M2M components which are able to perform functions of rNSCL.

According to embodiments of the present invention, M2M service capabilities can be replaced or changed depending on system conditions. According to embodiments of the present invention, it allows efficient operation of components and data sharing within the local networks.

### BRIEF DESCRIPTION OF THE DRAWINGS

FIG. 1 illustrates an ETSI M2M-based functional architecture.

FIG. 2 is a flowchart illustrating a local resource sharing method according to embodiments of the present invention.

FIG. 3A and FIG. 3B illustrate a local resource sharing state according to an embodiment of the present invention.

FIG. 4 is a flowchart illustrating operation of replacement capability component according to an embodiment of the present invention.

FIG. 5 is a flowchart illustrating operation of replacement inability components according to an embodiment of the present invention.

FIG. 6 illustrates an SCL address list sharing method according to an embodiment of the present invention.

FIG. 7 is a flowchart illustrating a NSCL restoring process according to an embodiment of the present invention.

FIG. 8 is a block view illustrating a functional architecture of replacement capability component according to an embodiment of the present invention.

### DESCRIPTION OF THE EXEMPLARY EMBODIMENTS

Hereinafter, in the following description with respect to embodiments of the present invention, when a detailed description of known functions or configurations related to the present invention unnecessarily obscures the gist of the present invention, a detailed description thereof will be omitted.

Certain embodiments of the invention will be described below in more detail with reference to the accompanying drawings.

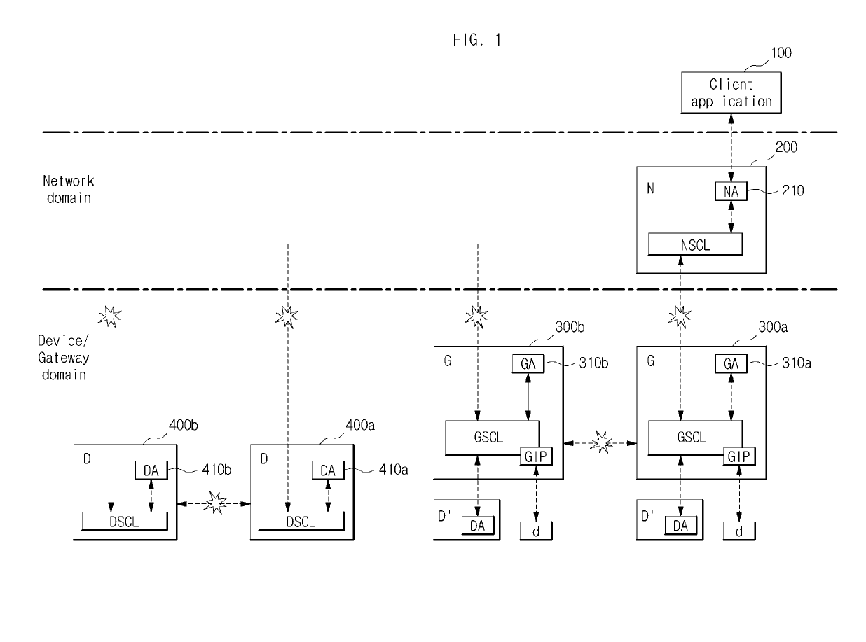

FIG. 1 illustrates an ETSI M2M-based functional architecture.

A Network Application (NA) 210 performs the same function as Gateway Applications (GA) 310a, 310b or Device Applications (DA) 410a, 410b, or performs additional business logic or algorithm. The NA 210 cannot perform any functions when the connection between a network domain and a device/gateway domain is disconnected for a long period of time. Information cannot be exchanged each other because components included in the device/gateway domain, for example gateway 300a, cannot exchange data or events directly with another gateway 300b which performs the same function.

When the connection between a network domain and a device/gateway domain is disconnected, a client application 100 cannot be coupled with local gateways 300a, 300b (at home) unless using a direct communication. Even though it is coupled with one gateway 300a through the GA 310a, it can only monitor the corresponding gateway 300a so that it requires to have a separate connection in order to couple with another gateway 300b. It may be the same in devices 400a, 400b.

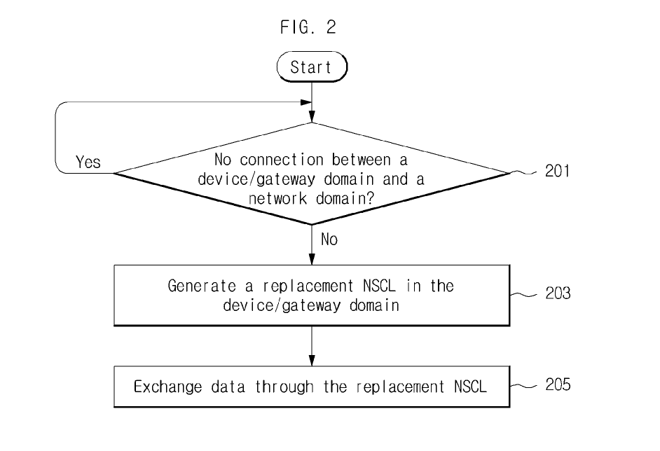

FIG. 2 is a flowchart illustrating a local resource sharing method according to embodiments of the present invention.

In Step 201, when the connection between the device/gateway domain and the network domain is fails, it proceeds to Step 203. Components in the device/gateway domain can determine if the domains are connected or not. The component in the device/gateway domain such as M2M gateway or M2M device (hereinafter, referring to as “gateway or device”) can perform a connection request to the component in the network domain such as a server.

The connection request can be made as many as it is determined and when there is no response for the connection request from the server, it then proceeds to Step 203. Here, the component which performs the connection request may be a component which possesses a Service Capability Layer (SCL) and performs communication with the network service capability layer (NSCL) in the network domain through the predetermined interface. The component may be a device or gateway and the SCL may be a Gateway Service Capability Layer (GSCL) or a Device Service Capability Layer (DSCL). The predetermined interface may be a M2M device interface (mId).

In Step 203, a replacement NSCL (rNSCL) is generated in the device/gateway domain. The rNSCL can be generated by components in the device/gateway domain. For example, when a connection request is made by a gateway in Step 201, the rNSCL can be generated by the corresponding gateway. When a connection request is made by a device in Step 201, the rNSCL can be generated by the corresponding device.

In Step 205, data is exchanged by using the rNSCL. For data exchange, other components in the device/gateway domain can be registered under the component where the rNSCL is generated. For example, when an rNSCL is generated in a gateway, the other gateways and devices possessing DSCL can be registered under the gateway where the rNSCL is generated. Data can be then exchanged through SCLs (DSCL, GSCL, rNSCL and NSCL) and the exchanged data can be provided to a client application.

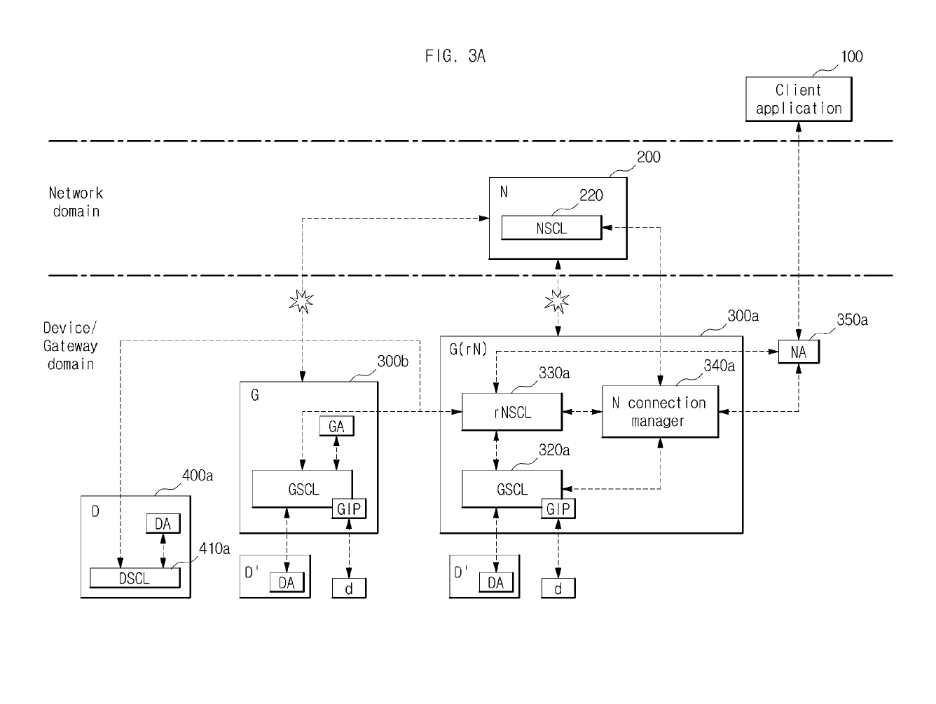

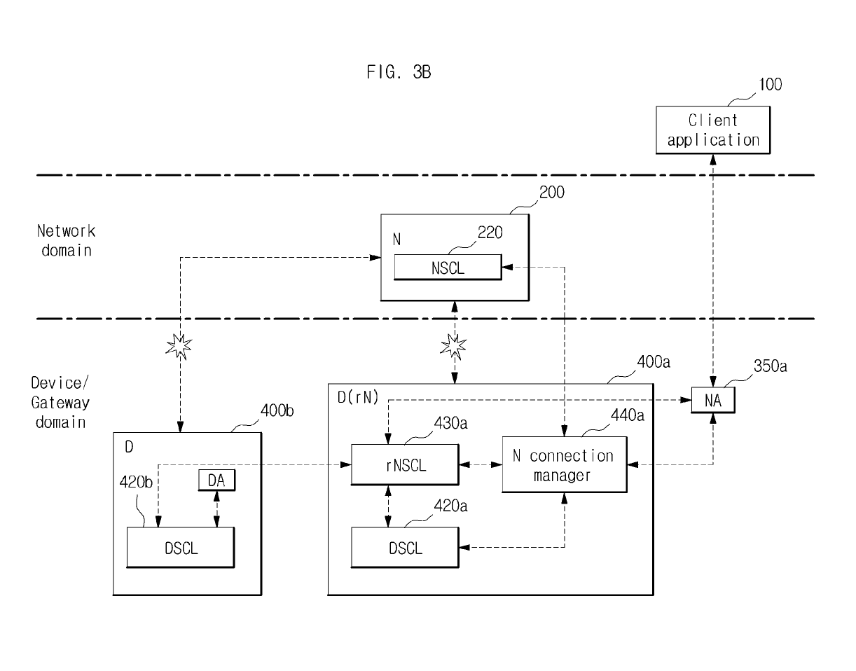

FIG. 3A and FIG. 3B illustrate a local resource sharing state according to an embodiment of the present invention.

FIG. 3A illustrates formation of an rNSCL 330a in a gateway 300a. Another gateway 300b and a device 400a possessing a DSCL 410a are registered under the gateway 300a to exchange data with the gateway 300a.

A GSCL 320a of the gateway 300a can be used by being connected to the rNSCL 330a and be stored in a storage area such as a memory area, a file system or a database while being in the state that operation is stopped. An N connection manager 340a can be generated while the rNSCL 330a is generated and tries to connect continuously to the server 200 to which it intends to connect originally. When the connection to the server 200 is made, the rNSCL 330a can be eliminated and connections between components can be restored. The NA 350a can be formed inside or outside the gateway 330a and performs communication with the client application 100.

FIG. 3B illustrates formation of an rNSCL 430a in a device 400a. Another device 400b possessing a DSCL 420b is connected under the device 400a to exchange data with the device 400a. Since other operations are identical to those explained for FIG. 3A, detailed explanation is omitted.

A component which can generate an rNSCL can be predetermined. The pre-determined component (hereinafter, referred to as “replacement capability component”) can generate the rNSCL in itself when the connection with a network domain is not made. A component which is not predetermined (hereinafter, referred to as “replacement inability component”) can perform operations to connect to the component which possesses the rNSCL when the connection with a network domain is not made.

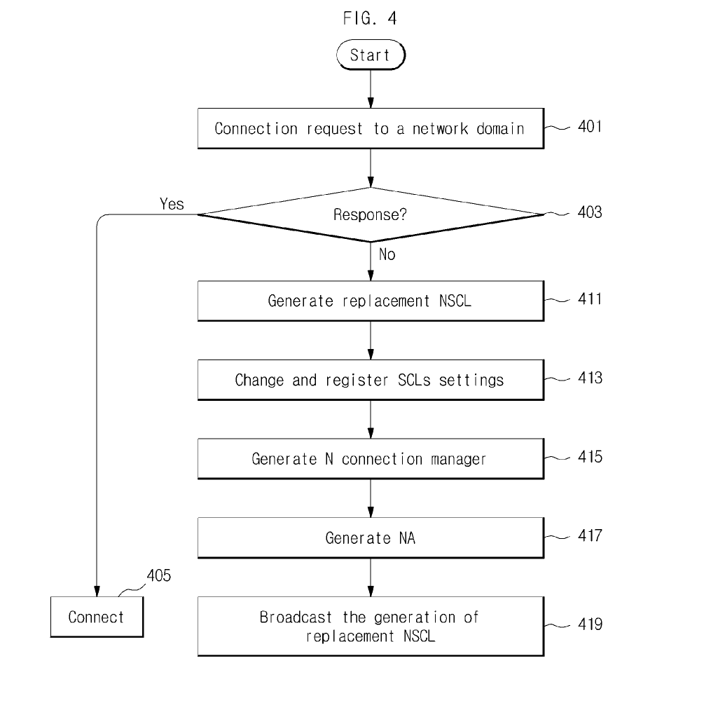

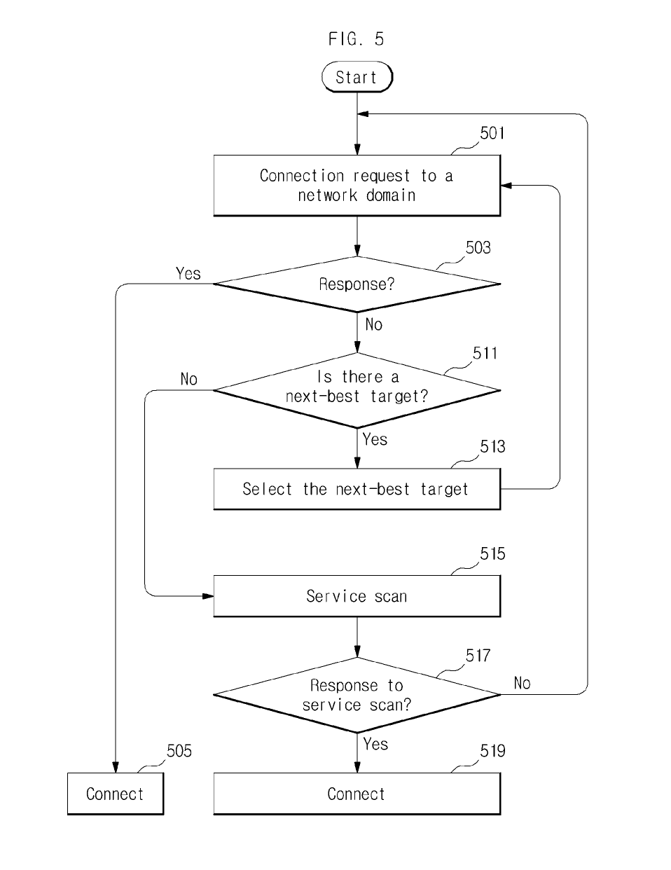

Operations to be conducted in the replacement capability component will be described with reference to FIG. 4 and those in the replacement inability component will be described with reference to FIG. 5.

FIG. 4 is a flowchart illustrating operation of replacement capability components according to an embodiment of the present invention. According to embodiments, at least one step of Step 401 to Step 419 may be omitted.

In Step 401, a replacement capability component performs a connection request to a network domain. The connection request may be conducted sequentially for at least one among a variety of servers which are able to provide M2M service capabilities in the network domain. The connection request may be to create, retrieve, update and/or delete (CRUD) a resource and be conducted by referring to a predetermined address list. The connection request may be conducted as many as it is determined.

In Step 403, the replacement capability component determines if a response to the connection request is made or not from the network domain and when the response is made, it proceeds to Step 405, while if not, it proceeds to Step 411.

In Step 405, the replacement capability component connects to the network domain.

Meanwhile, in Step 411 proceeded when the response to the connection request is not made from the network domain, the replacement capability component generates an rNSCL in a local area. According to embodiments, the replacement capability component may trigger an apparatus to generate an rNSCL in the corresponding apparatus, instead of generating an rNSCL in a local area.

The rNSCL may be generated based on a predetermined information or localNSCL. When the replacement capability component generates an rNSCL, it may determine if it eliminates or maintains an original SCL. For example, when the replacement capability component is a gateway, it may eliminate an existing GSCL or operate it with the rNSCL. Eliminating a SCL may mean transferring the SCL to a memory area in order to restore it later. Such a determination may be made based on its own capability or a system condition. Its own capability or a system condition may include at least one of area of free storage space, available memory resources and available process resources.

In Step 413, the replacement capability component performs setting changes and registrations of the SCLs. For example, when the replacement capability component is a gateway, it may register an existing GSCL under the rNSCL. It may also change a service port of the existing GSCL to another port and keep a record for the corresponding information while registering the SCLs. For example, the gateway may add information about the GSCL to the rNSCL and keep a record for the changed information (for example, changed information in service port) about the GSCL.

In Step 415, the replacement capability component may generate an N connection manager. The N connection manager may request for restoration of the NSCL to the server which performed the first connection request in Step 401 (hereinafter, referred to as “original server”) and requests for restoration of the NSCL. This will be described in detail with reference to the related drawings.

In Step 417, the replacement capability component may generate a representation of an NA. The NA may be generated based on metadata including specification and resource architecture, etc. which the replacement capability component itself has or can be obtained from an accessible external device such as a server. The NA may be registered under ‘sclBase’. The replacement capability component may have implementation such as Daemon program or obtain it from the external device to generate the NA. For this, the replacement capability component may exchange server/application (NA, etc) module binary and metadata and such exchanges may be performed periodically.

In Step 419, the replacement capability component may broadcast the fact that itself has the generated replacement NSCL therein. Scale for the broadcasting may be from local to global.

FIG. 5 is a flowchart illustrating operation of replacement inability components according to an embodiment of the present invention. According to embodiments, at least one step of Step 501 to Step 519 may be omitted.

In Step 501, a replacement inability component performs a connection request to a component which has an NSCL. The component having the NSCL may be a server existing in a network domain, or a device or gateway existing in a device/gateway domain and where an rNSCL is generated. The connection request may be to create, retrieve, update and/or delete (CRUD) a resource and be conducted by referring to an SCL address list. The connection request may be conducted as many as it is determined.

In Step 503, the replacement inability component determines if a response for the connection request is made from the component having the NSCL and proceeds to Step 505 when the response is made, while it proceeds to Step 511 if not.

In Step 505, the replacement inability component connects (including registration process) to the component having the NSCL.

Meanwhile, in Step 511 proceeded when the response to the connection request is not made from the component having the NSCL in Step 503, the replacement inability component determines if there is a next-best connection target. Determining if there is a next-best connection target may be determining if there is a server item, which has not tried a connection request, in an SCL address list. When it is determined as that there is the next-best target, it proceeds to Step 513.

In Step 513, the replacement inability component proceeds to Step 501 after selecting the next-best connection target. This selection may be made according to the order of items in the SCL address list or the order of priority assigned to each item. In Step 513, the replacement inability component may eliminate localNSCL for the server which does not respond to the pervious connection request. The localNSCL may be scl information which is generated by the replacement inability component while the replacement inability component is coupled with the component having M2M service capabilities. According to embodiments, the process for selecting the next-best connection target may be conducted based on system policies or user's inputs.

Meanwhile, in Step 515 proceeded when it is determined as that there is no next-best connection target, the replacement inability component performs service scan for the network. The service scan may be searching components where a replacement NSCL is generated. The service scan may be performed for example through port scan or using any protocol.

In Step 517, the replacement inability component determines if a response to the service scan is made and proceeds to Step 519 when it is determined as that the response is made to connect to the component which has responded. While it is determined as that the response is not made, it proceeds to Step 501 to perform a connection request.

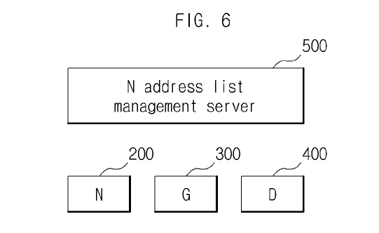

FIG. 6 illustrates a SCL address list sharing method according to an embodiment of the present invention.

A server 200, a gateway 300 and a device 400 can possess address for components having SCL (i.e., scl uri) autonomously or download from (or upload to) an SCL address list management server 500. Such addresses can be managed in a form of list or be stored in a file storing setting information to generate or search/connect a SCL. The file may be a setting file related to resource architectures, for example sclConfig and the like.

The SCL address list may include SCL addresses which can be the target to connect when the connection to the network domain is not possible or according to user's intention. The SCL address may be a scale from local to global. The global scale address may be a level to access with internet protocol (IP) or domain name. Order of the listed item in the SCL address list may be the order of priority, or separately marked information may indicate the order of priority for the corresponding items.

The SCL address list may include addresses of replacement capability components which are able to perform functions of rNSCL temporarily or permanently. The address of the replacement capability component may be expressed as IP, aliasing, Media Access Control (MAC) address and access information in the form of replaceable with other addresses.

The SCL address list management server 500 may provide the server item which is the closest to a corresponding gateway or device or has the most excellent performance to the gateway or device. The SCL address list management server 500 may also provide the server item which provides a certain service or a certain NA to the gateway or device.

The SCL address list management server 500 may designate the component (gateway or device) which has the most excellent performance in the local network as a replacement capability component, and broadcast the designated information in a local scale. The performance may be determined based on at least one of hardware specifications such as memory of a corresponding component, CPU and storage space, etc., network bandwidth and continuous driving time.

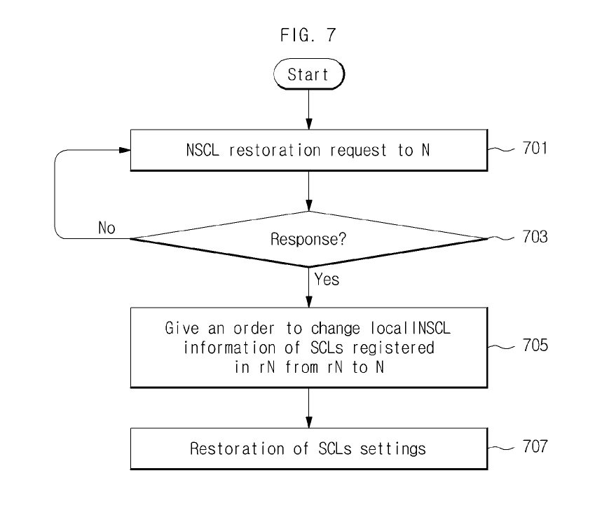

FIG. 7 is a flowchart illustrating a NSCL restoring process according to an embodiment of the present invention. The process illustrated in FIG. 7 may be processes to be performed after the generation of NSCL described with the reference to FIG. 4. According to embodiments, at least one step from the process illustrated in FIG. 7 may be omitted.

In Step 701, a replacement capability component performs a NSCL restoration request to a server. The NSCL restoration request may be performed when it is wanted to restore system settings to the state before the rNSCL is generated. The server to be a target of the NSCL restoration request may be a server to which the replacement capability component is to connect or a server to which it has connected, that is the original server. The request may be performed continuously. The request may be performed every predetermined period or as many as it is determined. In an embodiment of the present invention, the NSCL restoration request may be performed sequentially for servers existing in a predetermined address list such as SCL address list.

In Step 703, the replacement capability component determines if a response is made from the server and proceeds to Step 705 when it is determined as that the response is made.

In Step 705, the replacement capability component gives an order to the components registered under itself to change localNSCL information from itself to the original server. The replacement capability component may transmit information under sclBase thereof to sub-components registered under itself.

In Step 707, the replacement capability component restores SCLs settings. For example, the replacement capability component eliminates the rNSCL and restores SCL (GSCL or DSCL) which is stored in a storage or driven with the rNSCL to its original state (or position). The restoration process includes changing the service port of SCL to the original one.

In an embodiment of the present invention described with reference to FIG. 7, it is explained the embodiment in which the replacement capability component requests NSCL restoration to the server and recovers the system. However, according to embodiments, the NSCL generated in the replacement capability component may be continuously used within the local without performing the NSCL restoration request.

Therefore, the replacement capability component can exchange data with server while maintaining the connection with the components registered thereunder. It seems that the replacement capability component delivers data from a server's view. However, since more than one component under the replacement capability component are connected, the client application actually collects data by coupling only with the replacement capability component without recognizing additional resources (gateway or device) under the replacement capability component.

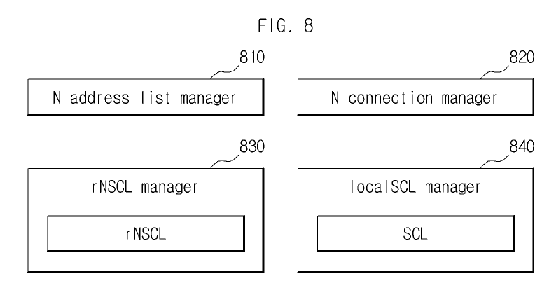

FIG. 8 is a block view illustrating a functional architecture of replacement capability components according to an embodiment of the present invention.

A replacement capability component according to an embodiment of the present invention includes an SCL address list manager 810, an N connection manager 820, an rNSCL manager 830 and a localSCL manager 840. At least one among them can be omitted.

The SCL address list manager 810 manages an SCL address list. The SCL address list may include addresses of a server or a replacement capability component. In an embodiment, the SCL address list may be received from the SCL address list management server. In this case, the SCL address list manager 810 may be coupled periodically with the SCL address list management server to update the SCL address list. According to embodiments, the SCL address list manager 810 can update the SCL address list through connection tests for the components in the SCL address list.

The N connection manager 820 may perform a connection request to an original server when an rNSCL is generated in the replacement capability component. This request may be made to request to restore the NSCL to the original server. This request may also request to restore an nsclBase resource. When the connection to the original server is restored, the components registered under the replacement capability component can replace the localNSCL information to the information of the original server. For example, when the original server performs respond for the NSCL restoration request to the replacement capability component, information under sclBase of the original server may be included in the response. The replacement capability component may transmit the received information under sclBase of the original server to the component registered thereunder before rNSCL is completed or when a request is made from the component registered thereunder. The information under sclBase may be stored in resource architecture (sclBase/scls/nscl) of the components registered thereunder.

When NSCL of the original server is restored, the component registered thereunder which is the replacement inability component then performs connection with the original server by referring to the nscl information which is localNSCL information.

Therefore, even though the rNSCL is eliminated, the sub-components connected to the replacement capability component may communicate with the original server.

The rNSCL manager 830 may generate or eliminate rNSCL. The rNSCL manager 830 may generate rNSCL in a local or a predetermined position according to system settings or user's inputs or when the connection with the server is not made. It may manage the rNSCL before the generated rNSCL is eliminated.

The rNSCL manager 830 may generate an NA based on metadata and broadcast the generation of the replacement NSCL. Information to be broadcasted may include information under sclBase.

The local SCL manager 840 may eliminate existing localSCL or set to drive with rNSCL when the rNSCL is generated. Here, the localSCL manager 840 changes a service port of the existing localSCL and registers the existing localSCL under the rNSCL. When the rNSCL is eliminated, the local SCL manager 840 may restore the service port of the localSCL to the original one. When the replacement capability component is a gateway, the localSCL may be a localGSCL, while the replacement capability component is a device, the localSCL may be a localDSCL.

The spirit of the present invention has been described by way of example hereinabove, and the embodiments of the present invention may be implemented by using hardware, software or a combination thereof. When they are implemented by software, they may be implemented as software executing in more than one processor using various operating systems or platforms. In addition, the software may be created by using any language among various appropriate programming languages or be compiled in machine language codes or intermediate codes executable in a framework or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. A local resource sharing method of machine to machine (M2M) component, the method comprising;
generating a replacement Network Service Capability Layer (NSCL) by a pre-determined component which is included in a device/gateway domain when the pre-determined component fails to make a connection to a network domain or a pre-determined request is made; and
performing, by the pre-determined component, communication with at least one of other components included in the device/gateway domain through the generated replacement NSCL.

2. The local resource sharing method of claim 1, further comprising:
changing, by the pre-determined component, a service port for an original Service Capability Layer (SCL) which is already presented before the replacement NSCL is generated; and
registering, by the pre-determined component, the original SCL under the replacement NSCL.

3. The local resource sharing method of claim 1, further comprising, after the generating a replacement NSCL:
performing, by the pre-determined component, a connection request to the network domain;
eliminating, by the pre-determined component, the replacement NSCL when being connected to the network domain; and
restoring, by the pre-determined component, the original SCL.

4. The local resource sharing method of claim 3, further comprising, when being connected to the network domain, transmitting information under sclBase of the network domain to components registered under the pre-determined component by the pre-determined component.

5. The local resource sharing method of claim 1, further comprising, after the generating a replacement NSCL, generating a Network Application (NA) in the device/gateway domain by the pre-determined component.

6. The local resource sharing method of claim 5, wherein the generating an NA comprises generating a NA based on metadata shared with the network domain or autonomously existing metadata.

7. The local resource sharing method of claim 1, further comprising broadcasting the generation of the replacement NSCL by the pre-determined component.

8. The local resource sharing method of claim 1, wherein the pre-determined component is a M2M gateway or a M2M device.

9. The local resource sharing method of claim 1, further comprising performing, by a component which is included in a device/gateway domain and is not pre-determined, a connection request to the pre-determined component by referring to a pre-determined address list when fails to make a connection to a network domain or a pre-determined request is made.

10. The local resource sharing method of claim 9, further comprising, when the component, which is not pre-determined, fails to make a connection to all components existing in the address list,
performing a service scan for the network; and
connecting to the component which has responded to the service scan.

11. The local resource sharing method of claim 9, further comprising accessing, by the pre-determined component or the component which is not pre-determined, a server which manages the address list in order to upload or download the address list

12. The local resource sharing method of claim 1, wherein the generating a replacement NSCL comprises generating the replacement NSCL in its own predetermined component or instructing to generate the replacement NSCL to an external device.

13. A machine to machine (M2M) component in a M2M component included in a device/gateway domain comprising:
a replacement Network Service Capability Layer (NSCL) manager configured to generate a replacement NSCL inside the M2M component when a connection to a network domain is not made or there is a pre-determined request; and
the replacement NSCL configured to perform communication with at least one of other components included in the device/gateway domain.

14. The machine to machine component of claim 13, further comprising a local SCL manager configured to change a service port for an original Service Capability Layer (SCL) which is already presented before the replacement NSCL is generated and register the original SCL under the replacement NSCL.

15. The machine to machine component of claim 13, further comprising:
a N connection manager configured to perform a connection request to the network domain after the replacement NSCL is generated,
wherein the replacement NSCL manager eliminates the replacement NSCL when the connection to the network domain is made, and
wherein the local SCL manager restores the original SCL.

16. The machine to machine component of claim 13, wherein the replacement NSCL manager generates a Network Application (NA) in the device/gateway domain.

17. The machine to machine component of claim 16, wherein the NA is generated based on metadata shared with the network domain or autonomously existing metadata.

18. The machine to machine component of claim 13, wherein the replacement NSCL manager broadcasts the generation of the replacement NSCL.

19. The machine to machine component of claim 13, wherein the M2M component is a M2M gateway or a M2M device.

20. The machine to machine component of claim 13, further comprising a SCL address list manager configured to access a server which manages an address list in order to upload or download the address list, wherein the address list comprise addresses of the M2M components which are able to perform functions of rNSCL.
